(19) United States
(12) Patent Application Publication
(10) Pub. No.: US 2019/0123396 A1
(43) Pub. Date: Apr. 25, 2019

(54) Method for Increasing the Safety of Lithium Ion Batteries, and Lithium Ion Battery with Increased Safety

(71) Applicant: Bayerische Motoren Werke Aktiengesellschaft, Muenchen (DE)

(72) Inventors: Ann-Christin GENTSCHEV, Belmont, CA (US); Holger HAIN, Ismaning (DE); Sebastian SCHARNER, Tuerkenfeld (DE); Barbara STIASZNY, Obergriesbach (DE)

(21) Appl. No.: 16/219,431

(22) Filed: Dec. 13, 2018

Related U.S. Application Data
(63) Continuation of application No. PCT/EP2017/064389, filed on Jun. 13, 2017.

(30) Foreign Application Priority Data
Jun. 14, 2016 (DE) 10 2016 210 562.0

(51) Int. Cl. H01M 10/42; H01M 10/0525; H01M 10/0567; H01M 10/0569

(52) U.S. Cl. CPC H01M 10/4235; H01M 10/0525; H01M 10/0565; H01M 10/0569; H01M 2300/0034; H01M 10/0567

(57) ABSTRACT

A lithium ion battery is provided having at least an electrolyte that has a solvent and, dissolved therein, a conducting salt containing lithium ions; and also has one or more safety means which increase the safety of the battery if the mode of functioning of the battery is impaired by an incident.

### CROSS REFERENCE TO RELATED APPLICATIONS

This application is a continuation of PCT International Application No. PCT/EP2017/064389, filed Jun. 13, 2017, which claims priority under 35 U.S.C. § 119 from German Patent Application No. 10 2016 210 562.0, filed Jun. 14, 2016, the entire disclosures of which are herein expressly incorporated by reference.

### BACKGROUND AND SUMMARY OF THE INVENTION

The present invention relates to a method for increasing the safety in lithium-ion batteries and a lithium-ion battery with increased safety.

Lithium-ion batteries consist at least of an anode, a cathode, and a separator separating the anode from the cathode, the separator being impregnated with an electrolyte. Rechargeable batteries of these kinds are used, for example, for operating electric vehicles. If the battery is damaged by a fault event such as, for example, by mechanical action or by internal short-circuiting or else by overcharging, there may be vigorous reactions between constituents of the electrolyte with constituents of the electrodes. These reactions may lead to a rise in temperature and pressure in the battery and to what is known as thermal runaway, with the possible consequences of bursting of the battery and a battery fire.

US 2008/0305403 relates to a lithium-ion battery which in the electrolyte contains a cyclic alkylene carbonate and a polymerization initiator for said carbonate. In the event of a rise in temperature in the battery, the carbonate undergoes polymerization, and the viscosity of the electrolyte goes up. A consequence of this in turn is that the electrical conductivity of the electrolyte decreases, meaning that there is an increase in the electrical resistance of the battery. This raises the safety of the battery.

An object of the invention is to provide further and improved measures with which the safety of a lithium-ion battery can be increased.

This and other objects of the invention are achieved in accordance with one or more aspects of the disclosure.

In one aspect of the invention, a method is provided for increasing the safety of a lithium-ion battery when the operation of the battery is adversely affected by a fault event, the fault event being brought about by one of more of the following:

(a) voltage increase of the battery consequent on overcharging of the battery;
(b) pressure increase consequent on formation of gas in the battery;
(c) temperature increase consequent on a short circuit or on heating of the battery; preferably (c);
where the battery includes an electrolyte which contains at least one solvent and lithium ions, the method includes at least one of the following steps (A1), (B), (C), (D1), (D2), (E1), (E2):
(A1) addition of a complexing agent so that lithium ions are complexed;
(B) addition of a quaternary ammonium fluoride which is soluble in the solvent of the electrolyte and has a better solubility therein than the conducting salt;
(C) addition of a solvent in which the conducting salt is insoluble;
(D1) addition of a polymerization initiator for a cyclic alkylene carbonate when the solvent of the electrolyte contains a cyclic alkylene carbonate;
(D2) addition of a polymerization initiator for an olefinic double bond when the solvent of the electrolyte has a polymerizable olefinic double bond;
(E1) addition of a polymer which, in the fault event, counteracts the possible decrease in the viscosity of the electrolyte;
where the complexing agent of step (A1), the quaternary ammonium fluoride of step (B), the solvent of step (C), the polymerization initiator of step (D1), the polymerization initiator of step (D2) or the polymer of step (E1) in the electrolyte is present immobilized in a release form and is released from this release form in the fault event and hence is added to the electrolyte;
or where the method includes at least the steps (A2) or (E2):
(A2) addition of a complexing agent for lithium ions that is sterically so designed that during normal operation of the battery it does not complex lithium ions, but in the fault event the steric hindrance is restricted in such a way that the complexing agent complexes lithium ions;
(E2) addition of a polymer which, in the case of fault, counteracts the possible decrease in the viscosity of the electrolyte;
where the complexing agent of step (A2) or the polymer of step (E2) are in solution or dispersed in the electrolyte.

The invention also relates to a method for increasing the safety of a lithium-ion battery when the operation of the battery is adversely affected by a fault event, the fault event being brought about by one of more of the following:

(a) voltage increase of the battery consequent on overcharging of the battery;
(b) pressure increase consequent on formation of gas in the battery;
(c) temperature increase consequent on a short circuit or on heating of the battery; preferably (c);
where the battery includes an electrolyte which contains at least one solvent and lithium ions, the method includes at least one of the following steps (A1), (B), (C), (D1), (D2), (E1), (E2):
(A1) addition of a complexing agent so that lithium ions are complexed and are no longer taken up by the anode;
(B) addition of a quaternary ammonium fluoride which is soluble in the solvent of the electrolyte and has a better solubility therein than the conducting salt, the solubility product of the conducting salt being lowered so that the salt precipitates;
(C) addition of a solvent in which the conducting salt is insoluble, so that it precipitates;
(D1) addition of a polymerization initiator for a cyclic alkylene carbonate when the solvent of the electrolyte contains a cyclic alkylene carbonate, so that the viscosity of the electrolyte increases;
(D2) addition of a polymerization initiator for an olefinic double bond when the solvent of the electrolyte has a polymerizable olefinic double bond, so that the viscosity of the electrolyte increases;
(E1) addition of a polymer which, in the fault event, counteracts the possible decrease in the viscosity of the electrolyte;
where the complexing agent of step (A1), the quaternary ammonium fluoride of step (B), the solvent of step (C), the polymerization initiator of step (D 1), the polymerization initiator of step (D2) or the polymer of step (E1) in the electrolyte is present immobilized in a release form and is released from this release form in the fault event and hence is added to the electrolyte;
or where the method includes at least the steps (A2) or (E2):
(A2) addition of a complexing agent for lithium ions that is sterically so designed that during normal operation of the battery it does not complex lithium ions, but in the fault event the steric hindrance is restricted in such a way that the complexing agent complexes lithium ions and these ions are no longer taken up by the anode;
(E2) addition of a polymer which, in the case of fault, counteracts the possible decrease in the viscosity of the electrolyte;
where the complexing agent of step (A2) or the polymer of step (E2) are in solution or dispersion in the electrolyte.

These method steps lower the electrical conductivity of the electrolyte and raise the electrical resistance of the battery. This results in an increase in the safety of the battery, since, for example, the danger of a thermal runaway is reduced or done away with entirely.

The invention further relates to a method for increasing the safety of a lithium-ion battery when the operation of the battery is adversely affected by a fault event, the fault event being brought about by one of more of the following:

(a) voltage increase of the battery consequent on overcharging of the battery;
(b) pressure increase consequent on formation of gas in the battery;
(c) temperature increase consequent on a short circuit or on heating of the battery; preferably (c);
where the battery includes an electrolyte which contains at least one solvent and lithium ions, the method comprising at least one of the following steps (A1), (B), (C), (D1), (D2), (E1), (E2):
(A1) addition of a complexing agent so that lithium ions are complexed and are no longer taken up by the anode, so that the electrical conductivity of the electrolyte is lowered and the electrical resistance of the battery increases;
(B) addition of a quaternary ammonium fluoride which is soluble in the solvent of the electrolyte and has a better solubility therein than the conducting salt, the solubility product of the conducting salt being lowered so that the salt precipitates, so that the electrical conductivity of the electrolyte is lowered and the electrical resistance of the battery increases;
(C) addition of a solvent in which the conducting salt is insoluble, so that it precipitates, so that the electrical conductivity of the electrolyte is lowered and the electrical resistance of the battery increases;
(D1) addition of a polymerization initiator for a cyclic alkylene carbonate when the solvent of the electrolyte contains a cyclic alkylene carbonate, so that the viscosity of the electrolyte increases, so that the electrical conductivity of the electrolyte is lowered and the electrical resistance of the battery increases;
(D2) addition of a polymerization initiator for an olefinic double bond when the solvent of the electrolyte has a polymerizable olefinic double bond, so that the viscosity of the electrolyte increases, so that the electrical conductivity of the electrolyte is lowered and the electrical resistance of the battery increases;
(E1) addition of a polymer which, in the fault event, counteracts the possible decrease in the viscosity of the electrolyte, so that the increase in the electrical conductivity of the electrolyte consequent on a reduced viscosity is also counteracted;
where the complexing agent of step (A1), the quaternary ammonium fluoride of step (B), the solvent of step (C), the polymerization initiator of step (D 1), the polymerization initiator of step (D2) or the polymer of step (E1) in the electrolyte is present immobilized in a release form and is released from this release form in the fault event and hence are added to the electrolyte;
or where the method includes at least the steps (A2) and (E2):
(A2) addition of a complexing agent for lithium ions that is sterically so designed that during normal operation of the battery it does not complex lithium ions, but in the fault event the steric hindrance is restricted in such a way that the complexing agent complexes lithium ions and these ions are no longer taken up by the anode, where the conductivity of the electrode is lowered and the resistance of the battery increases;
(E2) addition of a polymer which in the case of fault counteracts the possible decrease in viscosity of the electrolyte, so that the increase in the conductivity as a result of a reduced viscosity is also counteracted; where the complexing agent of step (A2) and the polymer of step (E2) are in solution or dispersed in the electrolyte.

The term “lithium-ion battery” as used herein denotes in particular a rechargeable lithium-ion battery of the kind used in electric vehicles. The construction of such batteries—that is, usable electrodes and electrode materials, electrolytes comprising solvent, and conducting salt—are well known to the skilled person and therefore need no more detailed elucidation at this point.

The complexing agent of step (A1) may be selected from suitable crown ethers, podands, lariat ethers, calixarenes, and calix crowns, provided that the cavities formed by these compounds are not too large for the complexing of the lithium ions. The classes of compound of crown ethers, podand, lariat ethers, calixarenes, and calix crown are the subject of general description, for example, in DE 10 2010 054 778 A1. The skilled person is able to select suitable compounds from these classes of compound that are appropriate for the complexing of lithium ions.

The complexing agent of step (A1) is preferably a crown ether or a cryptand.

The crown ether is preferably selected from 12-crown-4, dibenzo-12-crown-4, 15-crown-5, dibenzo-15-crown-5, and aza or thia analogs thereof.

The cryptand is preferably selected from [2.2.1]cryptand, [2.2.1]cryptand, and [2.2.2]cryptand.

The stated compounds are known to the skilled person.

The quaternary ammonium fluoride of step (B) is selected from the fluorides of R₁R₂R₃R₄N⁺, where R₁, R₂, R₃, and R₄ independently of one another are: C₁₋₂₅-alkyl or aryl, preferably phenyl, where aryl may be substituted by C₁₋₂₅-alkyl. In the solvents used in lithium-ion batteries, such compounds generally have a better solubility than the conducting salt, preferably LiPF₆. The skilled person, moreover, is in a position to select suitable quaternary fluorides which possess better solubility than the conducting salt.

The solvent of step (C) is preferably a non-polar organic solvent, preferably a linear, branched, cyclic or cycloaliphatic hydrocarbon or an aromatic hydrocarbon, more preferably having a boiling point of above 80° C.

Particularly suitable non-polar solvents are alkanes such as n-hexane, heptanes and octanes, and also toluene.

The polymerization initiator of step (D1) is preferably a base, a metal salt or a Lewis acid which is capable of ring-opening oligomerization or polymerization of the cyclic carbonate. Suitable bases are preferably selected from the group of trimethylamine (TEA), DBU (1,8-diazabicyclo[5.4.0]undec-7-ene), KOCH₃, NaOCH₃, KOC₂H₅, NaOC₂H₅, NaOH, KOH, Al(acac)₃, Cr(acac)₃, Co(acac)₃, Fe(acac)₃, Mn(acac)₃, Mn(acac)₂, MoO₂(acac)₂, Zn(acac)₂, AlCl₃, TiCl₄, ZnCl₂, Al(O-iPr)₃, Ti(OBu)₄, Sn(Ph)₃Cl, (n-Bu₃Sn)₂O, ZnEt₂, Bu₂Sn(OMe)₂, BDL, BDPH, 4-DMAP (4-dimethylaminopyridine), Zr(OPr)₄, BuLi, K₂CO₃, Na₂CO₃, RB₂CO₃, and Cs₂CO₃. These catalysts for the ring-opening of cyclic carbonates are described in US 2008/0305403 A1.

The organic cyclic carbonate of step (D1) preferably includes a carbonate such as ethylene carbonate or propylene carbonate.

In another embodiment, the solvent of step (D2) includes an olefinic double bond in the form of an acrylic double bond. Suitable catalysts for polymerization of such olefins are preferably radical initiators such as peroxides or azoisobutyronitrile.

In another embodiment, the polymer of step (E1) is selected from polymethacrylates and α-olefin copolymers. Polymers of these kinds are known. They are also known for use as thickeners or else viscosity improvers, as additives to engine oils, for instance.

In accordance with the invention, the complexing agent of step (A1), the quaternary ammonium fluoride of step (B), the solvent of step (C), the polymerization initiator of step (D1), the polymerization initiator of step (D2), and the polymer of step (E1) are immobilized in a release form in the electrolyte of the battery. When the fault event occurs, these compounds are released from the release form and bring about the effects depicted earlier on above.

The term “release form” as used herein means that the stated compounds are present in a form in which they are immobilized and are therefore not amenable to a reaction. Only if they are released from this form are they able to enter into the reactions of steps (A1), (B), (C), (D1), (D2) or (E1).

In one embodiment the release form is present in the form of inclusion immobilization, preferably as a microencapsulation or liposome.

In another embodiment, the release form is present in the form of micelles.

Accordingly, the immobilized release form in which the complexing agent of step (A1), the quaternary ammonium fluoride of step (B), the solvent of step (C), the polymerization initiator of step (D1), the polymerization initiator of step (D2), and the polymer of step (E1) may be present is selected from: microencapsulation, liposome or micelle.

Such release forms are known in principle to the skilled person, albeit in a different context.

In one embodiment, the microencapsulation may take place with wax. On an increase in temperature, the wax softens and melts, and, for example, the complexing agent of step (A1), the quaternary ammonium fluoride of step (B), the polymerization initiator of step (D1), the polymerization initiator of step (D2) or the polymer of step (E1) are released.

Where liposomes or micelles are used for the immobilization, these structures generally undergo collapse on an increase in temperature and release the complexing agent of step (A1), the quaternary ammonium fluoride of step (B), the solvent of step (C), the polymerization initiator of step (D1), the polymerization initiator of step (D2) or the polymer of step (E1).

In an alternative embodiment, suitable complexing agents for lithium ions of step (E2) or polymers of step (E2) which counteract the possible decrease in viscosity of the electrolyte in the case of fault may also be present in solution or dispersion in the electrolyte.

In one embodiment, the sterically hindered complexing agent of step (A2) is a crown ether or a cryptand. Substituted crown ethers or cryptands are used with preference. The substituents are preferably selected from alkyl chains or aralkyl chains.

The polymers of step (E2) may be identical to the polymers of step (E1).

In another aspect, the invention relates to a lithium-ion battery at least comprising an electrolyte comprising a solvent and a lithium-ion-containing conducting salt dissolved therein, and further comprising one or more safety agents (A1), (B), (C), (D1), (D2), (E1), (E2):

(A1) a complexing agent for lithium ions;
(B) a quaternary ammonium fluoride which is soluble in the solvent of the electrolyte and has a better solubility therein than the conducting salt;
(C) a solvent in which the conducting salt is insoluble;
(D1) a polymerization initiator for a cyclic alkylene carbonate when the solvent of the electrolyte contains a cyclic alkylene carbonate;
(D2) a polymerization initiator for an olefinic double bond when the solvent of the electrolyte has a polymerizable olefinic double bond;
(E1) a polymer which, in case of fault event, counteracts the possible decrease in the viscosity of the electrolyte;
where the complexing agent (A1), the quaternary ammonium fluoride (B), the solvent (C), the polymerization initiator (D1), the polymerization initiator (D2) or the polymer (E1) in the electrolyte is present immobilized in a release form and is released from this release form in the fault event; or
(A2) a complexing agent for lithium ions that is sterically so designed that during normal operation of the battery it does not complex lithium ions, but in the fault event the steric hindrance is restricted in such a way that the complexing agent complexes lithium ions;
(E2) a polymer which in the case of fault counteracts the possible decrease in the viscosity of the electrolyte; where the complexing agent of step (A2) and the polymer (E2) are in solution or dispersed in the electrolyte.

The invention more particularly relates to a lithium-ion battery at least having an electrolyte containing a solvent and a lithium-ion-containing conducting salt dissolved therein, and further contains one or more safety agents (A1), (B), (C), (D1), (D2), (E1), (E2), which increase the safety of the battery when the operation of the battery is adversely affected by a fault event:

(A1) a complexing agent for lithium ions;
(B) a quaternary ammonium fluoride which is soluble in the solvent of the electrolyte and has a better solubility therein than the conducting salt;
(C) a solvent in which the conducting salt is insoluble;
(D1) a polymerization initiator for a cyclic alkylene carbonate if the solvent of the electrolyte contains a cyclic alkylene carbonate;
(D2) a polymerization initiator for an olefinic double bond if the solvent of the electrolyte has a polymerizable olefinic double bond;
(E1) a polymer which in the fault event counteracts the possible decrease in the viscosity of the electrolyte;
where the complexing agent (A1), the quaternary ammonium fluoride (B), the solvent (C), the polymerization initiator (D1), the polymerization initiator (D2) or the polymer (E1) in the electrolyte is present immobilized in a release form and is released from this release form in the fault event; or
(A2) a complexing agent for lithium ions that is sterically so designed that during normal operation of the battery it does not complex lithium ions, but in the fault event the steric hindrance is restricted in such a way that the complexing agent complexes lithium ions;
(E2) a polymer which in the case of fault counteracts the possible decrease in viscosity of the electrolyte; where the complexing agent (A2) and the polymer (E2) are in solution or dispersed in the electrolyte.

In another aspect, the invention relates to the use of a complexing agent (A1), a quaternary ammonium fluoride (B), a solvent (C), a polymerization initiator (D1), a polymerization initiator (D2) or a polymer (E1), where the compounds are present immobilized in a release form selected from microencapsulation, liposome or micelle, or the invention relates to the use of a complexing agent (A2) or of a polymer (E2) to increase the safety of a lithium-ion battery, preferably in a fault event.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for increasing the safety of a lithium-ion battery, when the operation of the battery is adversely affected by a fault event, the fault event being brought about by one of more of the following:
(a) voltage increase of the battery consequent on overcharging of the battery;
(b) pressure increase consequent on formation of gas in the battery;
(c) temperature increase consequent on a short circuit or on heating of the battery;
wherein the battery comprises an electrolyte which contains at least one solvent and lithium ions,
the method comprising at least one of the following steps (A1), (B), (C), (D1), (D2), (E1), (E2):
(A1) adding a complexing agent so that lithium ions are complexed;
(B) adding a quaternary ammonium fluoride which is soluble in the solvent of the electrolyte and has a better solubility therein than the conducting salt;
(C) adding a solvent in which the conducting salt is insoluble;
(D1) adding a polymerization initiator for a cyclic alkylene carbonate when the solvent of the electrolyte comprises a cyclic alkylene carbonate;
(D2) adding a polymerization initiator for an olefinic double bond when the solvent of the electrolyte has a polymerizable olefinic double bond;
(E1) adding a polymer which, in the fault event, counteracts the possible decrease in the viscosity of the electrolyte;
wherein the complexing agent of step (A1), the quaternary ammonium fluoride of step (B), the solvent of step (C), the polymerization initiator of step (D1), the polymerization initiator of step (D2) or the polymer of step (E1) in the electrolyte is immobilized in a release form in the electrolyte and is released from this release form in the fault event and thus is added to the electrolyte;
or wherein the method comprises at least steps (A2) and (E2):
(A2) addition of a complexing agent for lithium ions that is sterically designed so that it does not complex lithium ions during the normal operation of the battery, but in the fault event, the steric hindrance is restricted in such a way that the complexing agent complexes lithium ions;
(E2) addition of a polymer which, in the fault event, counteracts the possible decrease in the viscosity of the electrolyte;
wherein the complexing agent of step (A2) and the polymer (E2) are dissolved or dispersed in the electrolyte.

2. The method according to claim 1, wherein the complexing agent of step (A1) is a crown ether selected from the group consisting of: 12-crown-4, dibenzo-12-crown-4, 15-crown-5, dibenzo-15-crown-5, and aza or thia analogs thereof, or is a cryptand selected from the group consisting of: [2.2.1]cryptand, [2.2.1]cryptand, and [2.2.2]cryptand.

3. The method according to claim 1, wherein the quaternary ammonium fluoride of step (B) is selected from the fluorides of R₁R₂R₃R₄N⁺, wherein R₁, R₂, R₃, R₄ independently of one another are: C₁₋₂₅-alkyl or aryl, wherein aryl may be substituted by C₁₋₂₅-alkyl.

4. The method according to claim 1, wherein the solvent of step (C) is a non-polar organic solvent.

5. The method according to claim 4, wherein the solvent is a linear, branched, cyclic or cycloaliphatic hydrocarbon or an aromatic hydrocarbon.

6. The method according claim 4, wherein the solvent has a boiling point of above 80° C.

7. The method according to claim 1, wherein the polymerization initiator of step (D1) is a base, a metal salt or a Lewis acid.

8. The method according to claim 1, wherein the cyclic alkyene carbonate is ethylene carbonate or propylene carbonate.

9. The method according to claim 1, wherein the polymerization initiator of step (D2) is a radical initiator and the solvent of step (D2) has an acrylic double bond.

10. The method according to claim 1, wherein the polymer of step (E1) or (E2) is selected from polymethacrylates and α-olefin copolymers.

11. The method according to claim 1, wherein the sterically hindered complexing agent of step (A2) is a crown ether or a cryptand.

12. The method according to claim 1, wherein the immobilized release form in which the complexing agent of step (A1), the quaternary ammonium fluoride of step (B), the solvent of step (C), the polymerization initiator of step (D1), the polymerization initiator of step (D2), and the polymer of step (E1) are selected from: immobilization by inclusion in a microencapsulation, or a liposome, or immobilization by micelle formation.

13. A lithium-ion battery comprising an electrolyte containing a solvent and a lithium-ion containing conducting salt dissolved therein, and further comprising one or more safety agents (A1), (B), (C), (D1), (D2), (E1), (E2), which increase the safety of the battery when the operation of the battery is adversely affected by a fault event:
(A1) a complexing agent for lithium ions;
(B) a quaternary ammonium fluoride which is soluble in the solvent of the electrolyte and has a better solubility therein than the conducting salt;
(C) a solvent in which the conducting salt is insoluble;
(D1) a polymerization initiator for a cyclic alkylene carbonate when the solvent of the electrolyte comprises a cyclic alkylene carbonate;
(D2) a polymerization initiator for an olefinic double bond when the solvent of the electrolyte has a polymerizable olefinic double bond;
(E1) a polymer which, in the fault event, counteracts the possible decrease in viscosity of the electrolyte;
wherein the complexing agent (A1), the quaternary ammonium fluoride (B), the solvent (C), the polymerization initiator (D1), the polymerization initiator (D2) or the polymer (E1) in the electrolyte is immobilized in a release form and is released from this release form in the fault event;
or
(A2) a complexing agent for lithium ions that is sterically designed so that it does not complex lithium ions during normal operation of the battery, but in the fault event, the steric hindrance is restricted in such a way that the complexing agent complexes lithium ions;
(E2) a polymer which, in the fault event, counteracts the possible decrease in the viscosity of the electrolyte;
wherein the complexing agent (A2) and the polymer (E2) are dissolved or dispersed in the electrolyte.
